(19) United States
(12) Patent Application Publication
(10) Pub. No.: US 2004/0131338 A1
(43) Pub. Date: Jul. 8, 2004

(54) Method of reproducing audio signal, and reproducing apparatus therefor

(76) Inventors: Kohei Asada, Kanagawa (JP); Tetsunori Itabashi, Kanagawa (JP)

Correspondence Address: JAY H. MAIOLI, Cooper & Dunham LLP, 1185 Avenue of the Americas, New York, NY, 10036, US

(21) Appl. No.: 10/706,772

(22) Filed: Nov. 12, 2003

(30) Foreign Application Priority Data
Nov. 19, 2002 (JP) P2002-334536

(51) Int. Cl. H04N 5/76

(52) U.S. Cl. 386/96

(57) ABSTRACT

The present invention intends to enlarge a range in which a proper position of sound image position is obtained, when a sound field is generated by a speaker array. A plurality of speakers constituting a speaker array and a plurality of digital filters to which an audio signal is supplied respectively are provided. Respective outputs of the digital filters are supplied to the speakers, respectively, and a sound field is generated inside closed space. Predetermined delay times are set for the digital filters, respectively. Consequently, sounds outputted from the speaker array are reflected by a wall surface of the closed space, and then supplied to a location of a listener inside the sound field at a sound pressure larger than that of a peripheral location.

### BACKGROUND OF THE INVENTION

1. Field of the Invention

The present invention relates to a method of and an apparatus for reproducing an audio signal suitable for applying to a home theater and the like.

2. Description of Related Art

As a speaker system which is preferable when it is applied to a home theater, an AV system and the like, there is proposed a speaker array such as disclosed in Japanese Laid Open Patent Application No. JPH9-233591.

FIG. 11 shows an example of a speaker array 10 of this kind. This speaker array 10 is configured such that a large number of speakers (speaker units) SP0 to SPn are arrayed. In this case, as an example, n=255 (wherein n is the number of speakers), and an aperture of each of the speakers is several cm. Thus, actually, the speakers SP0 to SPn are two-dimensionally arrayed on a flat surface. However, in the following explanation, for simplicity, the speakers SP0 to SPn are assumed to be horizontally aligned.

An audio signal is supplied from a source SC to delay circuits DL0 to DLn, and delayed by predetermined times τ0 to τn, respectively. Then, the delayed audio signals are supplied through power amplifies PA0 to PAn to the speakers SP0 to SPn, respectively. By the way, the delay times τ0 to τn of the delay circuits DL0 to DLn will be described later.

Then, sound waves outputted from the speakers SP0 to SPn are synthesized at any location, thereby sound pressures as the synthesized result are to be obtained. In this case, in order to make a sound pressure of an arbitrary place Ptg higher than that of a peripheral place at a sound field generated by the speakers SP0 to SPn in FIG. 11, following conditions are to be set. Provided that sign L0 to Ln means each distance from respective speaker SP0 to SPn to the place Ptg, and a sign s means a speed of sound, then the delay times τ0 to τn of the delay circuits DL0 to DLn are defined as follows:

τ0=(Ln−L0)/s

τ1=(Ln−L1)/s

τ2=(Ln−L2)/s

τn=(Ln−Ln)/s=0

By setting the conditions as above, when the audio signal outputted from the source SC is converted into the sound waves by the speakers SP0 to SPn and outputted, their sound waves are delayed by the times τ0 to τn as represented by the above-mentioned equations and to be outputted. Thus, when their sound waves arrive at the place Ptg, all of them arrive at the same time, and the sound pressure of the place Ptg becomes higher than that of the peripheral place. In short, in such a way that parallel lights are focused with a convex lens, the sound waves outputted from the speakers SP0 to SPn are focused to the place Ptg. For this reason, the place Ptg is hereafter referred to as a focal point.

By the way, in the home theater and the like, if the above-mentioned speaker array 10 is used to generate the sound field, they are arranged or configured, for example, as shown in FIG. 12. That is, in FIG. 12, a sign RM indicates a room (closed space) serving as a reproducing sound field. In FIG. 12, a section in a horizontal direction is defined as a rectangle, and the speaker array 10 is placed on one wall surface WLF of the short sides. Also, in case of FIG. 12, 9 listeners (or seats) HM1 to HM9 sit down in 3 columns and 3 rows while facing the speaker array 10.

Further, as shown in FIG. 13, a virtual image RM′ of the room RM is considered with a wall surface WLL on the left side as a center. This virtual image RM′ can be considered to be equivalent to an open space in FIG. 11, so that a focal point Ptg with regard to the audio signal of a left channel is set to a point at which a straight line connecting between a center of the speaker array 10 and a virtual image HM5′ of a central listener HM5 crosses the wall surface WLL. Then, as shown in FIG. 12, a virtual sound image of the left channel is generated at the focal point Ptg.

Similarly, as for the audio signal of a right channel, the focal point Ptg is directed to a wall surface WLR on the right side, thereby generating a virtual sound image of the right channel. The above-mentioned description is the base principle when the speaker array 10 is used to generate the sound field.

By the way, if the focal point Ptg is directed to the wall surface WLL (and WLR) as mentioned above, the effect in the position of sound image to each of the listeners HM1 to HM9 is reduced by the following reasons.

That is, now, in order to think a simple model, following conditions are taken. Namely, the attenuation of the sound wave caused by a distance is small inside the room RM, the absorption and attenuation of the sound caused by the listener and the like are small, and even a listener behind a certain listener can listen to the sound through diffraction.

Also, as mentioned above and as shown in FIG. 13, it is supposed that the focal point Ptg of the left channel is set to the point at which the straight line connecting between the center of the speaker array 10 and the virtual image HM5′ of the central listener HM5 crosses the wall surface WLL.

Then, also as shown in FIG. 14, the listener HM1 located the closest to the wall surface WLL strongly perceives the sound image in the direction of the focal point Ptg, as indicated by an arrow B1. Also, the listeners HM5, HM9 perceive the sound image in the direction of the focal point Ptg, as indicated by arrows B5, B9. However, at this time, since the listeners HM5, HM9 are located far from the focal point Ptg, the sound pressures at the locations of the listeners HM5, HM9 are dispersed and made smaller than that at the location of the listener HM1. Thus, the perception or the position of the sound image is made weaker correspondingly to it.

This fact can be also considered as follows. That is, as shown in FIG. 15, if the speaker array 10 radiates the sounds so that they are focused to a place of the focal point Ptg, the sounds outputted from the speakers SP0 to SPn are interfered to each other and enhanced at the focal point Ptg. When circular arcs C1, C5 and C9 each constituting a part of a concentric circle with the focal point Ptg as a center are considered, the farther they are located from the focal point Ptg, the weaker the enhancing force caused by the interference becomes. Thus, the sound pressures are dispersed and reduced.

Thus, if the listeners are located on the lines of the circular arcs C1, C5 and C9, the position of the sound is perceived in the central direction of the speaker array 10, as indicated by an arrow B0. However, the perception with regard to the position of the sound image becomes unclear as they are located farther from the focal point Ptg, namely, in the order of the circular arcs C1, C5 and C9. Hence, in FIGS. 12 to 14, the location in the position of the sound image becomes clear to the listener HM1. However, the location becomes slightly unclear to the listener HM5, and the location actually becomes fairly unclear to the listener HM9.

Moreover, the fact that the sounds outputted from the speaker array 10 are reflected by the wall surface WLL is used as shown in FIG. 13. However, at this time, also as shown in FIG. 16, there are sounds directly arriving at the listeners HM1 to HM9 from the speaker array 10. Thus, unless the reflected sound is made louder than the direct sound, the focal point Ptg becomes unclear. Consequently, the feeling of the necessary position of the sound image can not be obtained.

The present invention intends to solve the above-mentioned problems.

### SUMMARY OF THE INVENTION

The present invention intends to provide a method of reproducing an audio signal, which comprises: supplying an audio signal to a plurality of digital filters, respectively; generating a sound field inside closed space by supplying respective outputs of the plurality of digital filters to a plurality of speakers constituting a speaker array, respectively; and by setting predetermined delay times for the plurality of digital filters, respectively, supplying the sounds outputted from the speaker array to a location of a listener inside the sound field after being reflected by a wall surface of the closed space with a sound pressure larger than that of a peripheral location.

Thus, the focal point of the sounds is generated at the location of the listener, and the perception and the position of the sound image are improved.

According to the present invention, the sounds radiated from the speaker array are reflected by the wall surface and then focused to the location of the listener, thereby enlarging the range in which the position of the sound image can be strongly perceived. Also, the direct sound from the speaker array, since the location of the listener is the sound pressure reduced point, is hard to be heard. Thus, it never disturbs the position of the sound image.

Moreover, since the sound wave of the anti-phase is never used to reduce the direct sound, the spatial perceptive uncomfortable feeling caused by the anti-phase components is not given to the listener. Also, the large sound pressure is never induced in the unnecessary place. The influence of the change in the sound pressure never extends up to the focal point Ptg in which the focal point and the directivity are adjusted.

### BRIEF DESCRIPTION OF THE DRAWINGS

FIG. 1 is a plan view explaining the present invention;

FIG. 2 is a plan view explaining the present invention;

FIG. 3 is a property view explaining the present invention;

FIGS. 4A, 4B and 4C are property views explaining the present invention;

FIG. 5 is a view explaining the present invention;

FIG. 6 is a property view explaining the present invention;

FIG. 7 is a system view showing an embodiment of the present invention;

FIG. 8 is a plan view explaining the present invention;

FIG. 9 is a plan view explaining the present invention;

FIG. 10 is a sectional view explaining the present invention;

FIG. 11 is a system view explaining the present invention;

FIG. 12 is a plan view explaining the present invention;

FIG. 13 is a plan view explaining the present invention;

FIG. 14 is a plan view explaining the present invention;

FIG. 15 is a plan view explaining the present invention;

FIG. 16 is a plan view explaining the present invention; and

FIG. 17 is a plan view explaining the present invention;

### DESCRIPTION OF THE PREFERRED EMBODIMENTS

(1) Setting of Focal Point Ptg

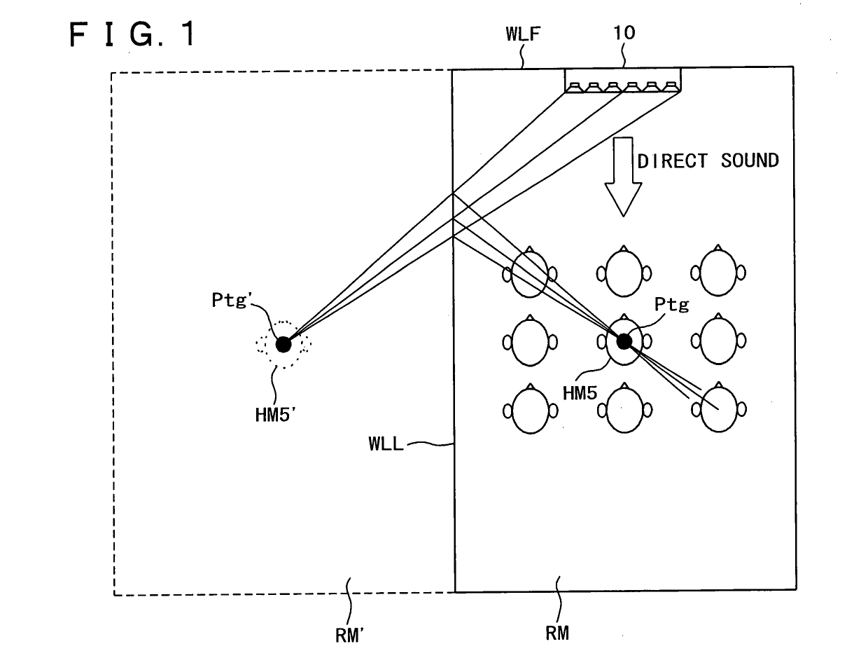

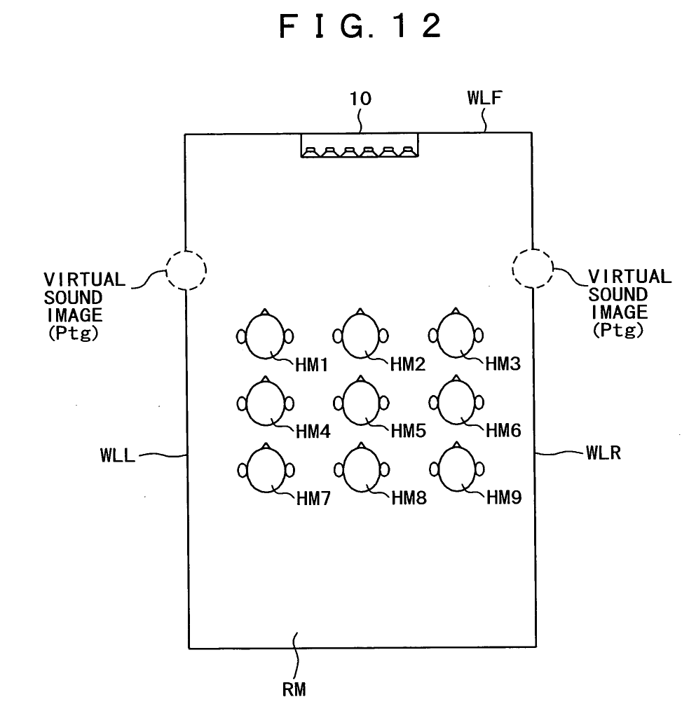

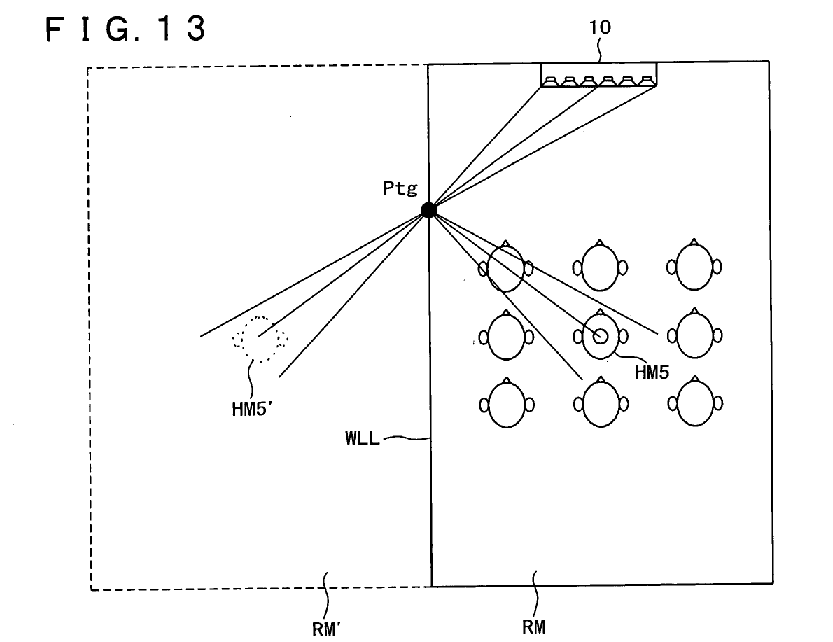

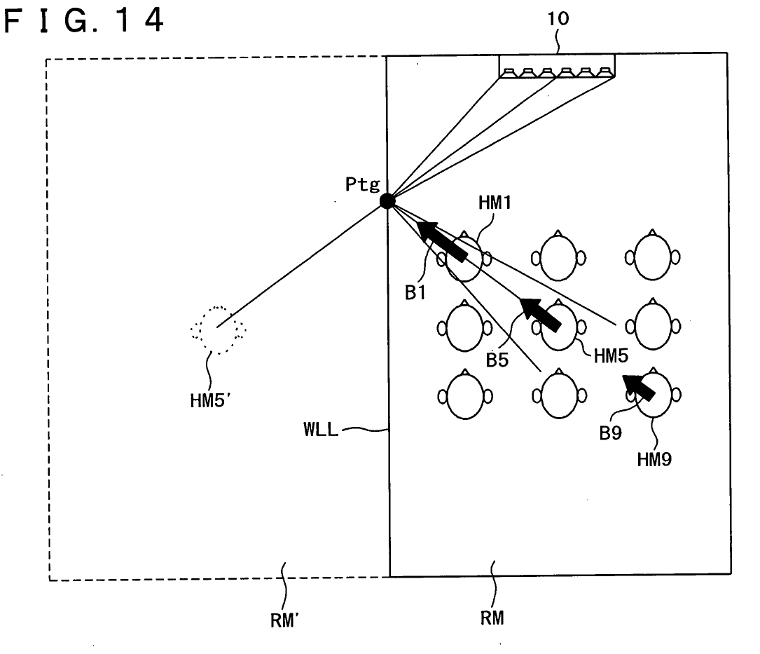

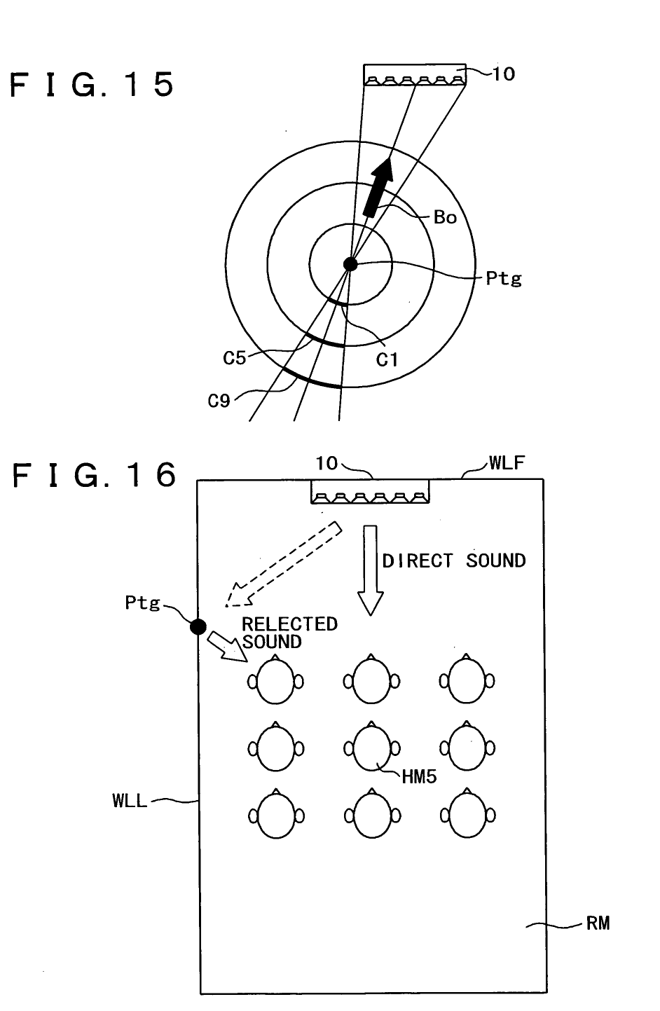

In the present invention, the focal point Ptg is set, for example, as shown in FIG. 1. That is, FIG. 1 is similar to the case of FIG. 12, wherein the room RM is rectangular, and the speaker array 10 is placed on one wall surface WLF of the short sides. Also, 9 listeners (or seats) HM1 to HM9 sit down in 3 columns and 3 rows while facing the speaker array 10.

Then, the virtual image RM′ of the room RM with a wall surface WLL as a center is considered, and a virtual focal point Ptg′ of the speaker array 10 is directed to a location of a virtual image RM5′ of a central listener HM5. Then, also as shown in FIG. 1, the actual focal point Ptg is located at the central listener HM5.

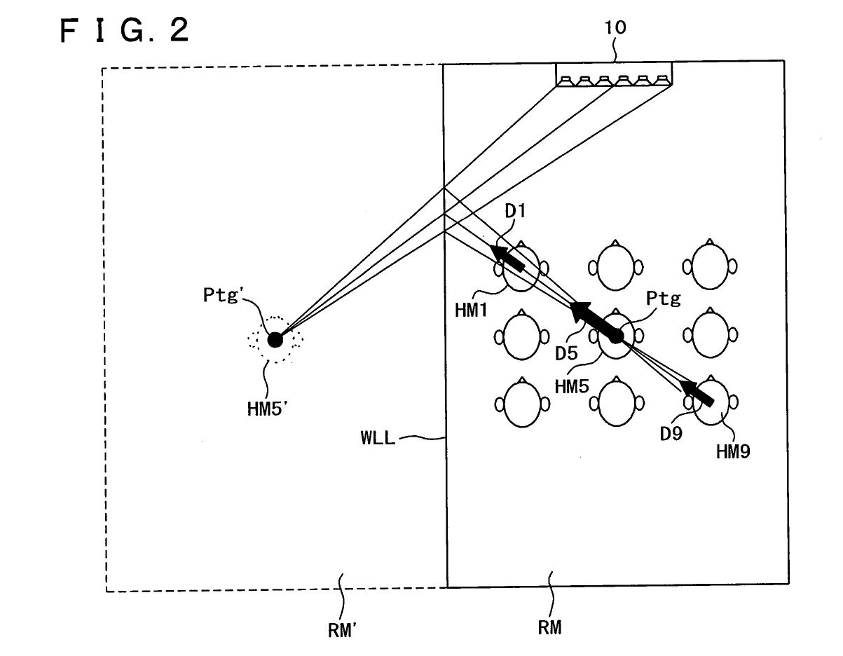

In this case, as indicated by arrows D1, D5 and D9 in FIG. 2, the listeners HM1, HM5 and HM9 perceive sound images in the same direction. At this time, since the focal point Ptg is focused on the location of the listener HM5, the listener HM5 strongly perceives the sound image. However, the listeners HM1, HM9, since located further from the focal point Ptg, perceive the sound image slightly weaker than the listener HM5. Also, a distance from the listeners HM1, HM9 to the focal point Ptg can be made shorter than a distance from the listeners HM1, HM9 in FIG. 14 to the focal point Ptg. Thus, the decrease of the sound pressures at the locations of the listeners HM1, HM9 are small than that of the case in FIG. 14, which correspondingly leads to make clear the position of the sound image than that of the case of FIG. 14. In short, the positions of the sound images are improved for the listeners HM1, HM5 and HM9.

(2) Process of Direct Sound

(2)-1 Outline of Process of Direct Sound

The outputs of the respective speakers in the speaker array 10 are synthesized in space and become the responses at the respective locations. Then, in the present invention, they are interpreted as pseudo digital filters. For example, in FIG. 16, when a place at which the direct sound from the speaker array 10 arrives is assumed to be a place Pnc, a response signal at the place Pnc is estimated, an amplitude is changed without changing a delay, and resultantly, a frequency property is controlled at the way when the digital filter is formed.

This control of the frequency property reduces the sound pressure at the place Pnc, and enlarges a band where the reduction of the sound pressure is possible, so that it is arranged to set the direct sound not to be heard as possible. Also, the sound pressure is reduced as natural as possible. In this case, the place Pnc is set, for example, to the location of the listener HM5.

(2)-2 Analysis of Speaker Array 10

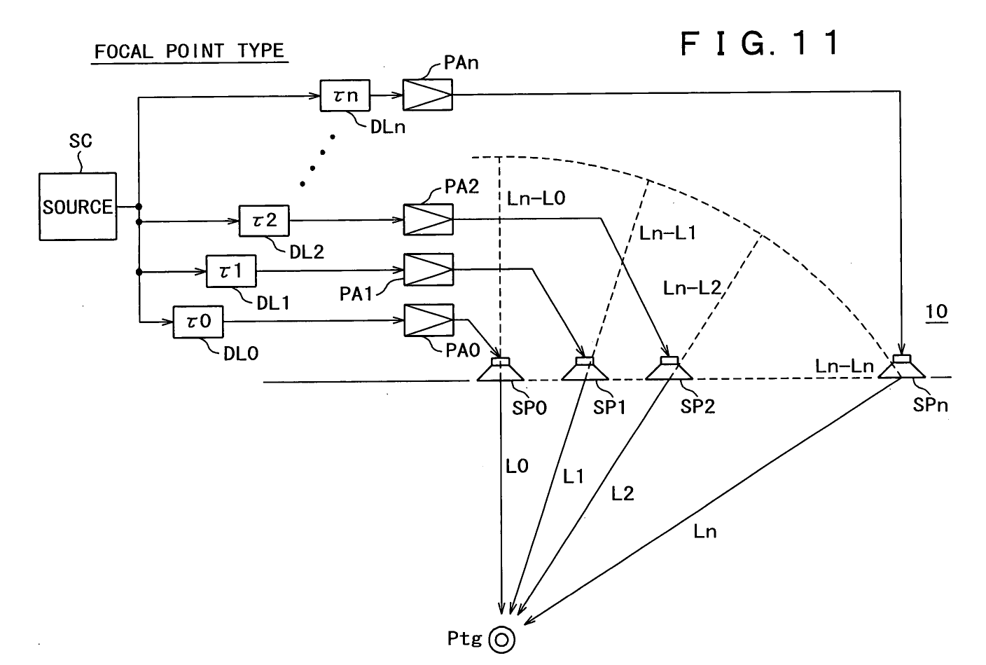

Here, for the purpose of simple explanation, it is assumed that a plurality of n speakers SP0 to SPn are horizontally aligned to configure the speaker array 10, and the speaker array 10 is to be configured as a focal point type system shown in FIG. 11.

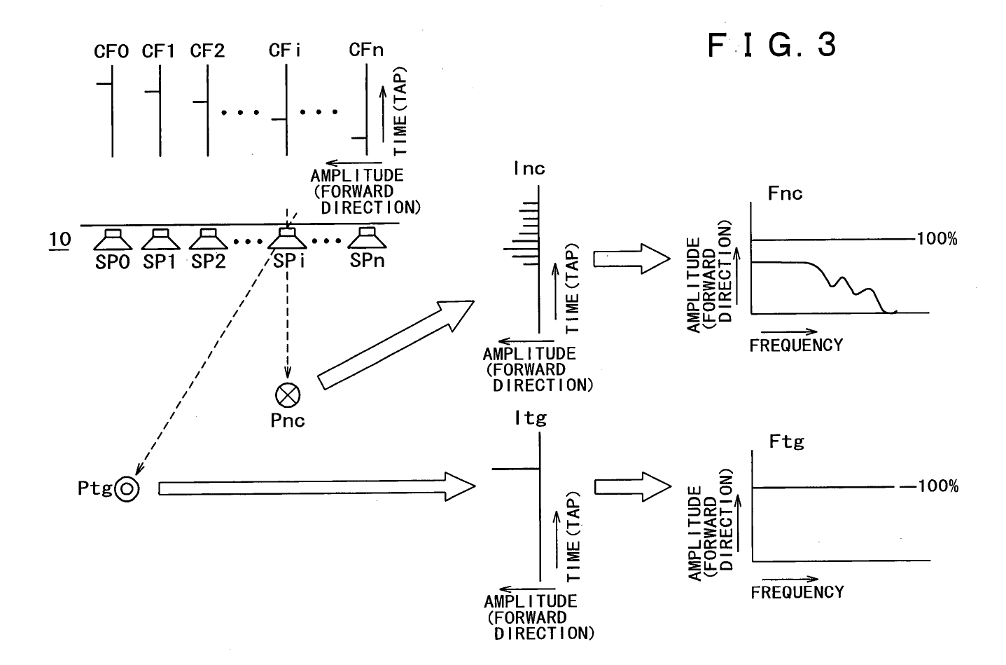

In this case, it is considered that each of delay circuits DL0 to DLn of this focal point type system is performed by an FIR (Finite Impulse Response) digital filter. Also, as shown in FIG. 3, filter coefficients of the FIR digital filters DL0 to DLn are represented by CF0 to CFn, respectively. However, the filter coefficients CF0 to CFn are set so as not to induce anti-phase components in the sound waves outputted from the speakers SP0 to SPn.

In addition, it is considered that an impulse is inputted to the FIR digital filters DL0 to DLn, and an output sound of the speaker array 10 is measured at the places Ptg, Pnc. In this case, this measurement is carried out in a frequency equal to or higher than a sampling frequency which a reproducing system including the digital filters DL0 to DLn employs.

Then, the response signals measured at the places Ptg, Pnc become the sum signals obtained by acoustically adding the sounds outputted from all of the speakers SP0 to SPn, and spatially propagated. At this time, the signals outputted from the speakers SP0 to SPn are the impulse signals delayed by the digital filters DL0 to DLn. In this case, hereafter, the response signal added through this spatial propagation is referred to as a spatially synthesized impulse response.

Then, for the place Ptg, the delay components of the digital filters DL0 to DLn are set in order to locate the focal point at that place. Thus, a spatially synthesized impulse response Itg measured at the place Ptg has one large impulse, also as shown in FIG. 3. A frequency response (an amplitude portion) Ptg of the spatially synthesized impulse response Itg becomes flat in the entire frequency band, also as shown in FIG. 3, because a temporal waveform is impulse-shaped. Thus, the place Ptg becomes the focal point.

By the way, actually, because of the frequency change at the time of spatial propagation, the reflection property of the wall in the course of a route, the displacement of the temporal axis defined by the sampling frequency and the like, the spatially synthesized impulse response Itg does not become the accurate impulse. However, here, for the purpose of the simple description, it is described as an ideal model.

On the other hand, a spatially synthesized impulse response Inc measured at the place Pnc is considered to be the synthesis of the impulses having respective temporal axis information. As shown in FIG. 3, the fact that it is the signal in which the impulses are dispersed under certain widths is known. At this time, the filter coefficients CF0 to CFn do not include the information related to the location of the place Pnc, and the filter coefficients CF0 to CFn are all based on the impulses in the positive direction. Thus, a frequency response Fnc of the spatially synthesized impulse response Inc does not have a factor of a phase opposite with regard to the amplitude direction.

As a result, as evident from the design principle of the FIR digital filter, the frequency response Fnc has the property of the tendency that it is flat in a low frequency region and it is attenuated as the frequency becomes higher, also as shown in FIG. 3, namely, it has the property close to that of a low pass filter. At this time, although the spatially synthesized impulse response Itg at the focal point Ptg exhibits one large impulse, the spatially synthesized impulse response Inc at the place Pnc exhibits the dispersed impulses. Thus, a level of the frequency response Fnc at the place Pnc becomes lower than a level of the frequency response Ftg at the location Ptg. In short, the sound pressure is reduced at the place Pnc, and the output sound of the speaker array 10 is hard to be heard.

At this time, when the spatially synthesized impulse response Inc is considered to be one spatial FIR digital filter, this FIR digital filter is originally configured by the sum of the amplitude values of the impulses including the temporal factors at the filter coefficients CF0 to CFn. Thus, if the contents (the amplitude, the phase and the like) of the filter coefficients CF0 to CFn are changed, the frequency response Fnc is changed. In short, it is possible to change the frequency response Fnc of the sound pressure at the sound pressure reduced point Pnc by changing the filter coefficients CF0 to CFn.

From the above-mentioned description, if the delay circuits DL0 to DLn are composed of the FIR digital filters and if their filter coefficients CF0 to CFn are selected, the focal point Ptg and the sound pressure reduced point Pnc can be set for the location of the listener HM5.

(2)-3 Spatially Synthesized Impulse Response Inc

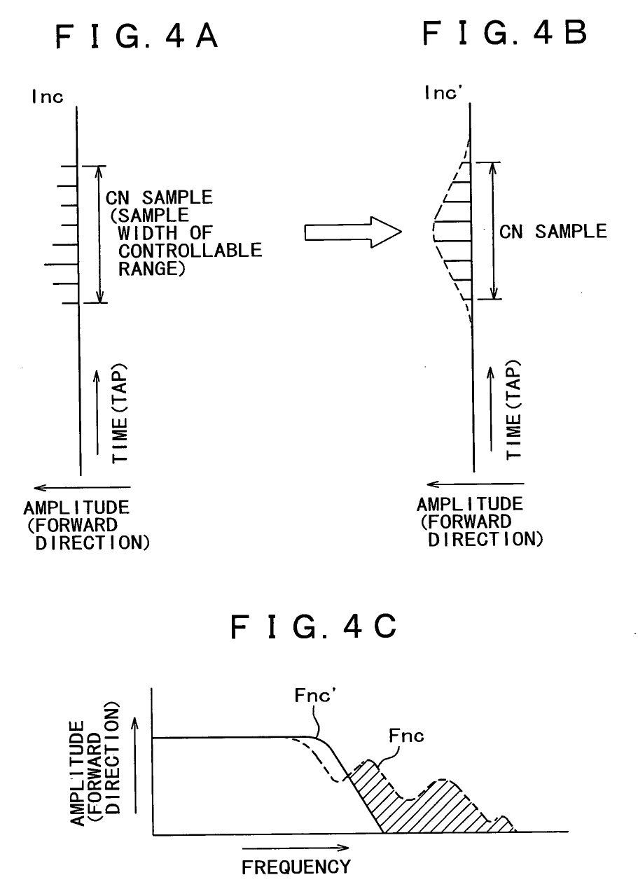

In the room RM shown in FIG. 1, if the location of the listener HM5 is determined, the location of the focal point Ptg is also determined, which consequently determines the delay times of the filter coefficients CF0 to CFn. Also, if the location of the listener HM5 is determined, the location of the sound pressure reduced point Pnc is also determined, which consequently determines the location from which the pulse of the spatially synthesized impulse response Inc at the sound pressure reduced point Pnc rises, also as shown in FIG. 4A (FIG. 4A is equal to the spatially synthesized impulse response Inc in FIG. 3). Also, by changing amplitude values A0 to An of the pulses in the digital filters DL0 to DLn, a controllable sample width (the number of the pulses) becomes a sample width CN in FIG. 4A.

Thus, by changing the amplitude values A0 to An, it is possible to change the pulses (in the sample width CN) shown in FIG. 4A into pulses (spatially synthesized impulse response) Inc′ of a level distribution, for example, as shown in FIG. 4B, and can change its frequency response from the frequency response Fnc into a frequency response Fnc′, as shown in FIG. 4C.

In short, the sound pressure at the sound pressure reduced point Pnc can be reduced correspondingly to the band of the portion where oblique lines are drawn in FIG. 4C. Thus, in the case of FIG. 1, with regard to the sound from a targeted direction, leakage sound (direct sound) from a front is reduced so that the targeted sound can be well heard.

The important item at this time is that even in a case of a pulse train such as a spatially synthesized impulse response Inc′ after the amplitudes A0 to An are changed, as for the spatially synthesized impulse response Itg and the frequency response Ftg of the focal point Ptg, only the amplitude value is changed and the uniform frequency property can be held. So, in the present invention, by changing the amplitude values A0 to An, the frequency response Fnc′ is obtained at the sound pressure reduced point Pnc.

(2)-4 How to Determine Spatially Synthesized Impulse Response Inc′

Here, a method of determining the necessary spatially synthesized impulse response Inc′ based on the spatially synthesized impulse response Inc is explained.

Typically, when the low pass filter is constituted by the FIR digital filter, a design method using a window function such as Hamming, Hanning, Kaiser, Blackman or the like is famous. It is known that the frequency response of the filter designed by those methods has the cutoff property which is relatively sharp. However, in this case, the pulse width that can be controlled on the basis of the amplitudes A0 to An is defined as the CN sample. Thus, within this range, the window function is used to carry out the design. If the shape of the window function and the number of the CN samples are determined, the cutoff frequency of the frequency response Fnc′ is also determined.

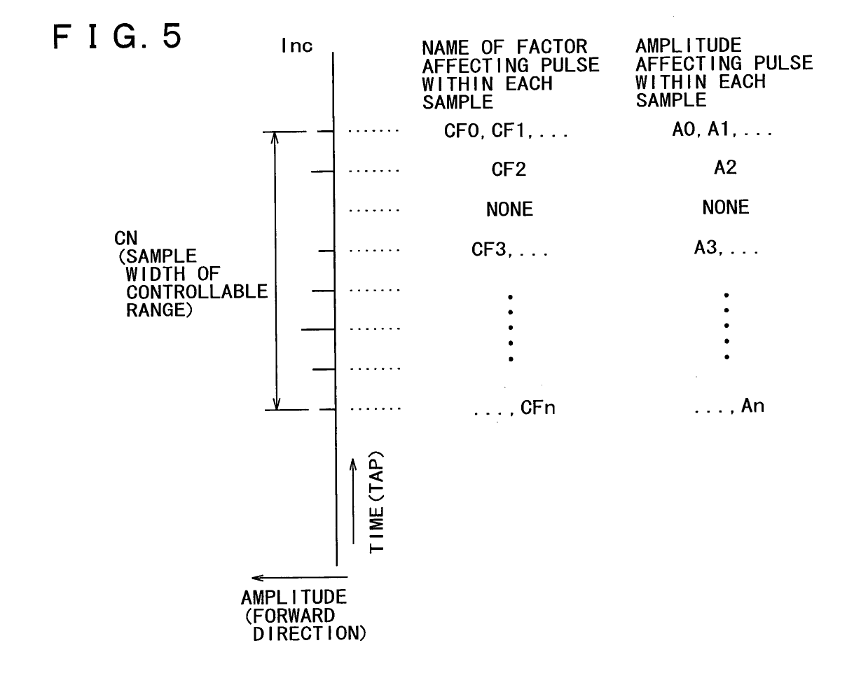

This is the method of determining the specific values of the amplitudes A0 to An based on the window function and the CN sample. However, for example, as shown in FIG. 5, by specifying a coefficient having influence on sample within CN width in the spatially synthesized impulse response Inc in advance, the amplitudes A0 to An can be specified to carry out a back calculation. In this case, a plurality of coefficients may have influence on one of pulses in the spatially synthesized impulse response Inc. Also, if the number of the corresponding coefficients (namely, the number of the speakers SP0 to SPn) is small, as exemplified in FIG. 5, there may be no corresponding coefficient.

By the way, the width of the window of the window function is desired to be approximately equal to the distribution width of the CN samples. Also, if the plurality of coefficients have the influence on one of pulses in the spatially synthesized impulse response Inc, they may be distributed. In this distributing method, the amplitude which has little influence on the spatially synthesized impulse response Itg and has great influence on the spatially synthesized impulse response Inc′ is desired to be preferentially targeted for adjustment, although it is not explained here.

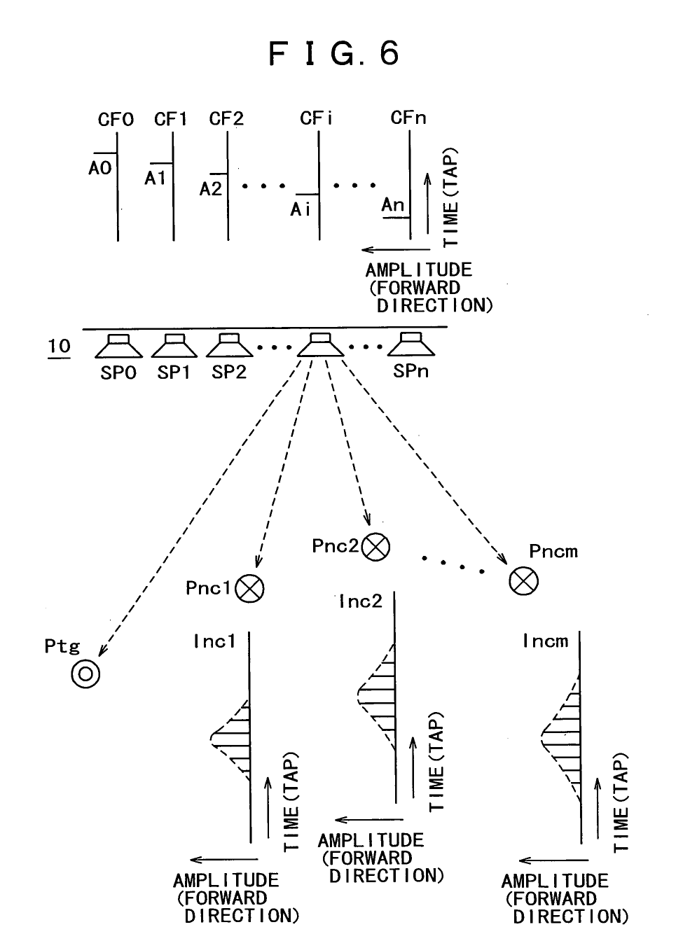

Moreover, as shown in FIG. 6, a plurality of sound pressure reduced points Pnc1 to Pncm are defined as the sound pressure reduced point Pnc, and the amplitudes A0 to An to satisfy them can be determined from simultaneous equations. If the simultaneous equations are not satisfied, or if the amplitudes A0 to An having the influence on the particular pulse in the spatially synthesized impulse response Inc are not corresponding as shown in FIG. 5, the amplitudes A0 to An can be determined by using a least square method so as to close to a curve of the targeted window function.

For example, it is possible to set the filter coefficients CF0 to CF31 correspond to the sound pressure reduced point Pnc1, set the filter coefficients CF32 to CF63 correspond to the sound pressure reduced point Pnc2, and set the filter coefficients CF64 to CF95 correspond to the sound pressure reduced point Pnc3, or carry out another operation, or nest the relation between the filter coefficients CF0 to CFn and the sound pressure reduced points Pcnl to Pcnm. Moreover, by devising the sampling frequency, the unit number of the speakers, and the spatial arrangement, it can be designed such that the coefficients having the influence on the respective pulses of the spatially synthesized impulse response Inc are present at as high a probability as possible.

By the way, since the sounds radiated from the speakers SP0 to SPn are propagated through the space that is continuous system, although the number of the coefficients having the influence on each pulse is not strictly limited to 1, the spatially synthesized impulse response Inc is treated, so as to easily serve as an indicator of the time of the calculation, for the convenience in this case, similarly to the dispersion at the time of the measurement. Even if such treatment is done, the fact that there is no practical problem is verified from experiment.

(3) Embodiment

(3)-1 First Embodiment

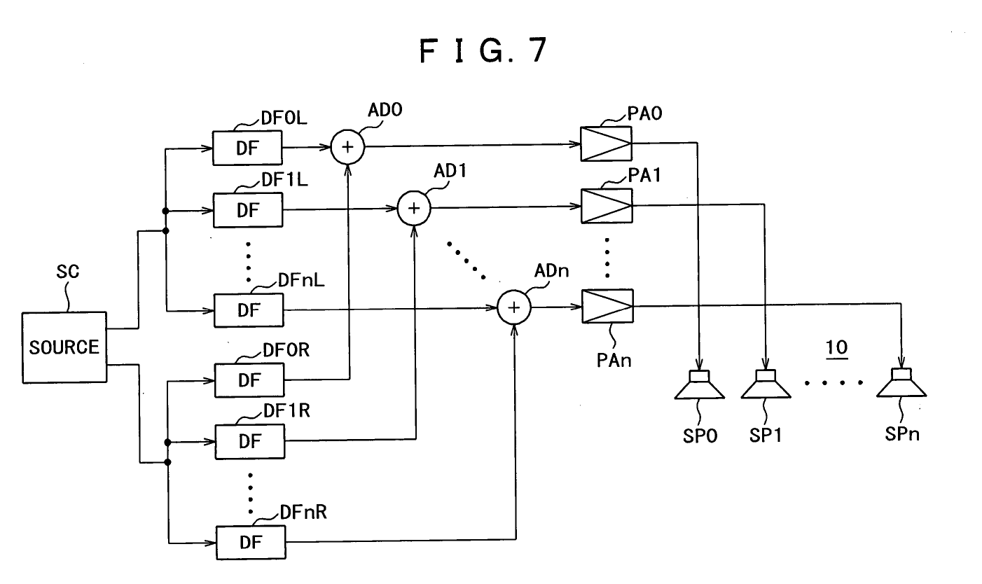

FIG. 7 shows an example of a reproducing apparatus according to the present invention, and FIG. 7 shows a case of a two-channel stereo system. That is, a digital audio signal of a left channel is taken out from a source SC, this audio signal is supplied to FIR digital filters DF0L to DFnL, and their filter outputs are supplied to adding circuits AD0 to ADn. Also, a digital audio signal of a right channel is taken out from the source SC, this audio signal is supplied to FIR digital filters DFOR to DFnR, and their filter outputs are supplied to the adding circuits AD0 to ADn. Then, the outputs of the adding circuits AD0 to ADn are supplied through power amplifiers PA0 to PAn to the speakers SP0 to SPn.

In this case, the digital filters DFOL to DFnL constitute the above-mentioned delay circuits DL0 to DLn. Then, their filter coefficients CF0 to CFn are defined such that after the sounds of the left channel outputted from the speaker array 10 are reflected by a left wall surface, the focal point Ptg is directed to the location of the listener HM5, and the sound pressure reduced point Pnc of the direct sound from the speaker array 10 becomes the location of the listener HM5. Similarly, in the digital filters DFOR to DFnR, their filter coefficients CF0 to CFn are defined such that after the sounds of the right channel outputted from the speaker array 10 are reflected by a right wall surface, the focal point Ptg is directed to the location of the listener HM5, and the sound pressure reduced point Pnc of the direct sound from the speaker array 10 becomes the location of the listener HM5.

Also, in the power amplifiers PA0 to PAn, the digital audio signals supplied thereto then power-amplified or D-class-amplified after D/A-conversion and supplied to the speakers SP0 to SPn.

According to such configuration, the sounds of the left channel outputted from the speaker array 10 are reflected by the left wall surface, and the focal point Ptg is directed to the location of the listener HM5, and the sounds of the right channel outputted from the speaker array 10 are reflected by the right wall surface, and the focal point is directed to the location of the listener HM5. Thus, the sound field of the stereo system is obtained.

At this time, since the location of the listener HM5 is the sound pressure reduced point Pnc, the direct sound from the speaker array 10 is hard to be heard. Thus, the direct sound never disturbs the position of the sound image. Moreover, since the sound wave of an anti-phase is never used to reduce the direct sound, the spatially perceptively uncomfortable feeling caused by the anti-phase components has no influence on the listener. Also, the large sound pressure is not induced in an unnecessary place, and the influence of the change in the sound pressure never extends up to the focal point Ptg at which the focal point and directivity are adjusted.

(3)-2 Second Embodiment

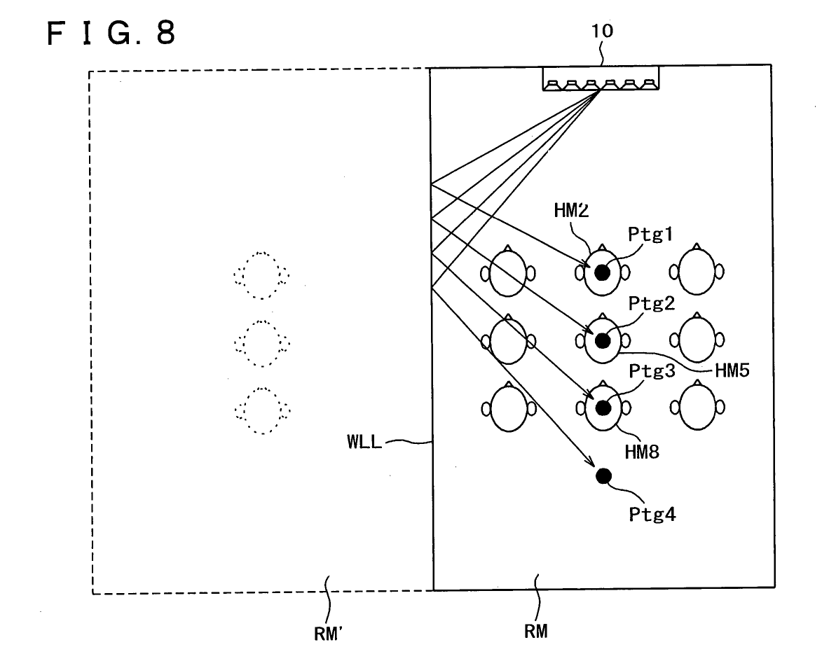

FIG. 8 shows a case in which the speakers SP0 to SPn are divided into a plurality of groups, for example, four groups, and focal points Ptg1, Ptg2, Ptg3 and Ptg4 are directed to respective locations in each group. Thus, in this case, it is possible to enlarge an area in which the strong position feeling is given. In this case, although all of the listeners can not perceive the sound image at the perfectively same location, there is no change in the manner that the sound image is perceived in front of the left wall surface. Hence, each of the listeners can obtain very strong feeling for the position of the sound image.

(3)-3 Third Embodiment

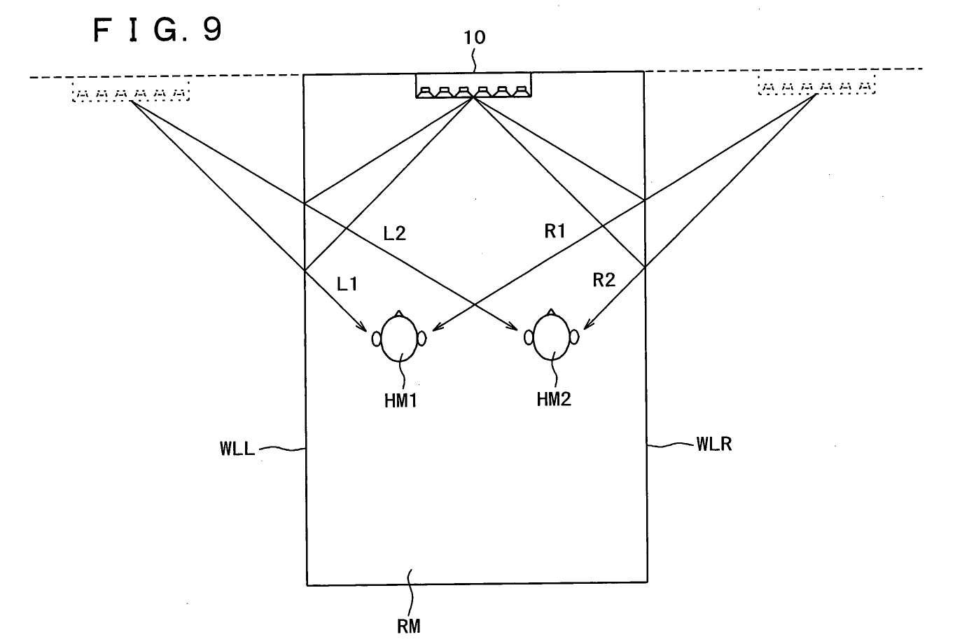

FIG. 9 shows a case that the listeners HM1, HM2 stay to the right and left, and listen to the music and the like in the room RM. In this case, the speakers SP0 to SPn of the speaker array 10 are divided into four groups. Then, sounds L1, L2 of the left channels are outputted from the first group and the second group, those sounds L1, L2 are reflected by the left wall surface WLL, and focused to the locations of the listeners HM1, HM2. Sounds R1, R2 of the right channels are outputted from the third group and the fourth group, reflected by the right wall surface WLR, and focused to the locations of the listeners HM1, HM2.

Thus, even if the listeners HM1, HM2 stay, each of them can obtain proper position of the sound image.

(3)-4 Fourth Embodiment

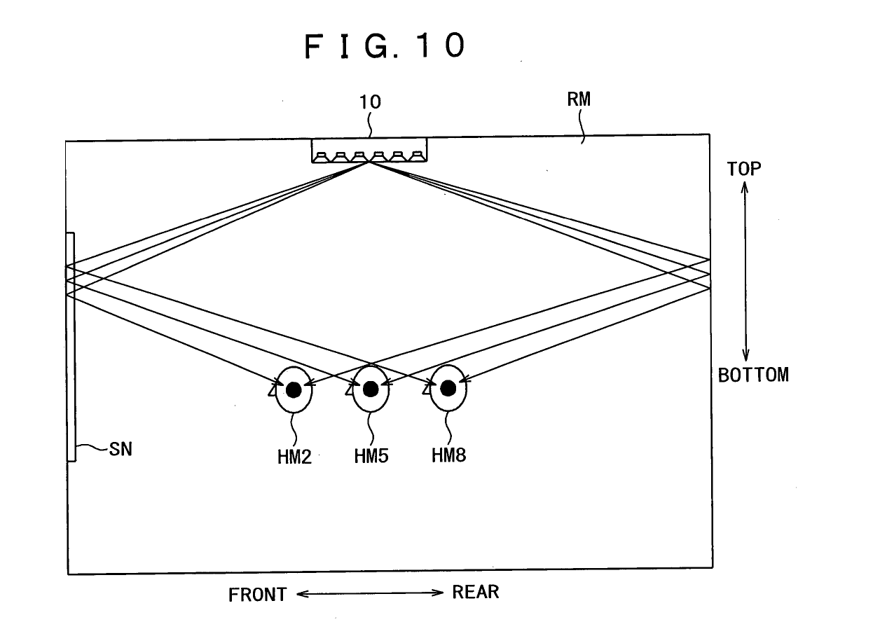

FIG. 10 shows a case that the speaker array 10 is placed on a ceiling, in the home theater system or the like. That is, a screen SN is placed on a front wall surface of the room RM. On the ceiling, the speaker array 10 is placed such that its main array direction is arranged to be forward and backward directions.

Then, the speakers SP0 to SPn of the speaker array 10 are divided into a plurality of groups. The sounds outputted from the respective groups are reflected by the front wall surface (or the screen SN) or the rear wall surface, and focused to each of the listeners HM2, HM5 and HM8. Thus, the respective listeners can perceive the sound image at the approximately same forward and backward locations.

(4) Others

In the above-mentioned description, if the listener or user indicates the number of the focal points Ptg and the locations thereof, the locations of the focal points Ptg and the size of a service area (an area in which a proper sound image position can be obtained) may be changed. Also, a sensor using an infrared ray, a supersonic wave and the like or a CCD (Charge Coupled Device) imaging device is used to automatically detect the number of the listeners and the locations thereof. Then, the number of the focal points and the locations thereof can be defined in accordance with the detected result.

Moreover, by controlling the number of the focal points and the locations thereof, the sound can be provided only to a listener who wants to listen to. Also, by sending a different source to each listener, a sound having different content can be given to each listener. Thereby, in the same room, each listener can listen to a different music, and can enjoy a television program or a movie with a different language.

Moreover, in the above-mentioned description, the window function is used as the design policy of the spatially synthesized impulse response Inc′, and designed a low pass filter property which is relatively sharp. However, it may use a function other than the window function, adjust the amplitude of the coefficient, and obtain the desirable property.

Also, in the above-mentioned description, the amplitudes of the filter coefficients are all assumed to be the pulse train in the positive direction so that the spatially synthesized impulse responses are all defined as the pulse train of the positive amplitudes. However, the property of the sound pressure reduced point Pnc may be defined by setting the pulse amplitudes of the respective filter coefficients to the positive or negative direction while keeping the delay property to direct the focal point to the focal point Ptg.

Moreover, in the above-mentioned description, the impulse is basically used as the element for adding the delay. However, this is taken as to make the explanation easy. This basic part can be exchanged to taps for a plurality of samples having the particular frequency responses. For example, it may install the functions of a low pass filter, a high pass filter and the like. Also, if a pseudo pulse train that can exhibit an effect of a pseudo over-sampling is basically used, even the negative components in the amplitude direction can be included in the coefficient.

Also, in the above-mentioned description, the delay with respect to the digital audio signal is represented by the coefficient of the digital filter. However, even if the system is configured by dividing into a delay unit and a digital filter unit, it can be similarly done. Moreover, one or a plurality of groups of combinations of the amplitudes A0 to An are prepared, and this can be set for at least one of the targeted focal point Ptg and sound pressure reduced point Pnc. Also, if the application of the speaker array is fixed and the typical reflection point and listening location and the like can be assumed, the filter coefficients can be also defined as the fixed filter coefficients CF0 to CFn corresponding to the preliminarily assumed focal point Ptg and sound pressure reduced point Pnc.

Moreover, in the above-mentioned description, when the amplitudes A0 to An of the filter coefficient corresponding to the spatially synthesized impulse response Inc′ are determined, the influence of the attenuation caused by air is not considered. However, a simulating calculation can be carried out by including the parameters such as an air attenuation on the way, a phase change caused by a reflection object and the like. Also, any measuring unit is used to measure the respective parameters and determine the further proper amplitudes A0 to An, thereby enabling the further accurate simulation.

Also, in the above-mentioned description, the speaker array 10 is configured such that the speakers SP0 to SPn are arrayed on the horizontal straight line. However, they may be arrayed on a plan surface. Or, they may be arrayed in the depth direction. Moreover, they need not to be always regularly arrayed.

What is claimed is:

1. A method of reproducing an audio signal, comprising the steps of:
supplying an audio signal to a plurality of digital filters, respectively;
generating a sound field inside closed space by supplying respective outputs of the plurality of digital filters to a plurality of speakers constituting a speaker array, respectively; and
supplying the sounds outputted from the speaker array to a location of a listener inside the sound field after being reflected by a wall surface of the closed space with a sound pressure larger than that of a peripheral location by setting predetermined delay times for said plurality of digital filters, respectively.

2. The method of reproducing an audio signal according to claim 1, wherein
a sound pressure directly arriving at said listener from said speaker array is reduced by setting predetermined amplitudes to said plurality of digital filters, respectively.

3. An apparatus for reproducing an audio signal, comprising:
a plurality of speakers constituting a speaker array; and
a plurality of digital filters to which an audio signal is supplied, respectively, wherein
a sound field is generated inside closed space by supplying respective outputs of said plurality of digital filters to said plurality of speakers, respectively; and
the sounds outputted from the speaker array are supplyed to a location of a listener inside the sound field after being reflected by a wall surface of the closed space with a sound pressure larger than that of a peripheral location by setting predetermined delay times for said plurality of digital filters, respectively.

4. The apparatus for reproducing an audio signal, according to claim 3, wherein
a sound pressure directly arriving at said listener from said speaker array is reduced by setting predetermined amplitudes to said plurality of digital filters, respectively.
